(19) United States
(12) Patent Application Publication
(10) Pub. No.: US 2026/0000086 A1
(43) Pub. Date: Jan. 1, 2026

(54) METHODS FOR PREPARING TURMERIC (CURCUMA LONGA) RHIZOMA EXTRACT AND ITS EMULSIFIABLE CONCENTRATE FORMULATION, AND USE THEREOF IN PREVENTION AND CONTROL OF PLANT POWDERY MILDEW

(71) Applicant: SHANGHAI JIAO TONG UNIVERSITY, Shanghai (CN)

(72) Inventors: Guanghui DAI, Shanghai (CN); Yanxin ZHANG, Shanghai (CN)

(73) Assignee: SHANGHAI JIAO TONG UNIVERSITY, Shanghai (CN)

(21) Appl. No.: 19/320,146

(22) Filed: Sep. 5, 2025

Related U.S. Application Data
(63) Continuation-in-part of application No. PCT/CN2023/096990, filed on May 30, 2023.
(63) Continuation-in-part of application No. PCT/CN2023/096997, filed on May 30, 2023.

(30) Foreign Application Priority Data
Mar. 9, 2023 (CN) 202310221795.8
Apr. 27, 2023 (CN) 202310471673.4

(51) Int. Cl. A01N 65/48; A01N 25/04; A01P 3/00

(52) U.S. Cl. CPC A01N 65/48; A01N 25/04; A01P 3/00

(57) ABSTRACT

Provided method for preparing a Curcuma longae rhizome extract, the method comprises: drying and pulverizing the plant raw materials, then extracting with an aqueous ethanol solution to obtain an extract liquid; concentrating the extract liquid, and extracting same with an organic solvent to obtain an aqueous-phase product and an oil-phase product; and performing molecular distillation on the oil-phase product to remove turmeric oleoresin and obtain the product. This extract is safe with low toxicity, rapidly biodegradable, and less likely to induce drug resistance. This extract is combined with both an emulsifier and a solvent to prepare an emulsifiable concentrate which to control the plant powdery mildew. This emulsifiable concentrate exhibits stable physicochemical properties, a long storage period, and low toxicity to organisms in terrestrial environments.

### CROSS-REFERENCE TO RELATED APPLICATION(S)

This is a continuation-in-part application of International Patent Application No. PCT/CN2023/096990, filed on May 30, 2023, which is based on and claims priority to Chinese Patent Application No. 202310471673.4, filed on Apr. 27, 2023. This application is also a continuation-in-part application of International Patent Application No. PCT/CN2023/096997, filed on May 30, 2023, which is based on and claims priority to Chinese Patent Application No. 202310221795.8, filed on Mar. 9, 2023. The disclosures of the above-listed applications are incorporated herein by reference in their entireties.

### TECHNICAL FIELD

The present application belongs to the technical field of preparation process of plant extracts, and relates to methods for preparing a turmeric (Curcuma longa) rhizome extract and an emulsifiable concentrate formulation of Curcuma longa rhizome extract, and use thereof in the prevention and control of plant powdery mildew.

### BACKGROUND

Powdery mildew, a fungal disease, can occur throughout the entire growth period of plants, primarily harming leaves, stems, and fruits. In the early stages of infection, white lesions appear and the color gradually turns to light brown, and black perithecium may be formed through self-fertilization or hybridization. Initially, the mildews are scattered separately but later merge into a large mildew lesion, and sometimes, the large mildew covers the entire leaf, which severely impairs photosynthesis, disrupts normal metabolism, accelerates premature aging, and reduces crop yield and quality.

In leguminous plants, powdery mildew mainly affects the leaves. Early symptoms include the formation of nearly circular powdery white mildew on the leaves, or the formation of purple-brown spots on the underside of leaves, covering with a thin layer of white powder—the superficial vegetative hyphae of the pathogen. These spots later merge into powdery spots as the reproductive hyphae produce abundant conidia. In severe cases, the spots coalesce, covering the entire leaf and causing the leaf to wither or fall off.

Roses, valued for their ornamental, medicinal, and edible uses, have effects such as refreshing the spleen, relieving depression, dredging meridians, promoting blood circulation, and enhancing beauty. With rising living standards, market demand for roses is increasing, leading to supply shortages in recent years. Powdery mildew is a common disease affecting roses and other Rosaceae plants. Infected leaves and young shoots develop a white powdery coating, which can turn leaves yellow and cause them to drop when severe, stunting growth and flowering of the plant, and resulting in significant economic losses for growers. Conventional prevention and treatments include spraying with a 1000-fold dilution of 70% thiophanate-methyl or a 2000-fold dilution of 50% amobam. However, the long-term use of these synthetic chemical fungicides leads to pathogen resistance, reducing efficacy and requiring increased pesticide application, which further harms the environment and food safety.

Grapes, rich in nutritional and medicinal value, have seen expanding cultivation areas in China. However, grapevines are susceptible to various diseases, with powdery mildew being a major threat. The grape powdery mildew affects green parts such as fruits, leaves, and young shoots, with fruit damage causing the greatest losses. Infected fruits develop a gray-white powdery mold, while leaves become covered in a similar coating and gradually spread to the entire leaf, eventually causing the leaf to curl and wither. Young shoots initially show small gray-white spots that spread and darken to dark gray and finally black, severely impacting grape yield and quality. Current control methods include spraying a lime-sulpher-synthetic-solution with 3-5 Baume degrees and a lime-sulpher-synthetic-solution with 0.2-0.5 Baume degrees, or a 500-fold dilution of 50% thiophanate, or a 1000-fold dilution of 70% thiophanate-methyl, or a 1000-fold dilution of 25% triadimefon wettable powder, for one time before and after budbreak, respectively. However, the spraying of conventional chemical synthetic agents causes a series of problems, such as pathogen resistance and pesticide residues. Therefore, it is necessary to effectively improve the conventional prevention and control of grape powdery mildew.

In agricultural production, the use of synthetic chemical pesticides has long accounted for the vast majority of the total amount of pesticides used, but with the continuous promotion and use of synthetic chemical pesticides, their disadvantages have gradually emerged. Synthetic chemical pesticides are difficult to degrade and have high toxicity. Long-term use of synthetic chemical pesticides can easily lead to resistance, thereby reducing or even losing the prevention and control effect. Moreover, synthetic chemical pesticides entering the environment can easily cause environmental pollution. Some chemical pesticides that are difficult to degrade may even be continuously enriched through the food chain and eventually enter the human body, causing harm to human health. Nowadays, under the pursuit of green and environmental protection, the use of synthetic chemical pesticides has gradually decreased, while in contrast, the gradual development of biopesticides. Biopesticides refer to a type of pesticide preparation that uses biological living organisms or their metabolites that can prevent and control pests, bacteria, weeds, nematodes, rats and other pests, or substances with specific effects synthesized through bionics as active ingredients. The active ingredients mainly come from animals, plants, and microorganisms. Plant-derived pesticides are a major component of biological pesticides.

Plant-derived pesticides are novel pesticides developed using plants themselves or effective active ingredients extracted from plants that have a prevention and control effect on plant pests and weeds. Among the various plant resources in the world, many plant resources contain effective active substances for preventing and controlling diseases and eliminating pests, including Tanacetum cinerariifolium, Melia azedarach, etc. Plant-derived pesticides have abundant plant resources that can be developed and broad prospects for industrialization.

Curcuma longa L., a perennial herb of the family Zingiberaceae and genus Curcuma, and is also a common Chinese herbal material. This plant contains chemical components such as curcumin, turmeric oleoresins, and volatile oils. The plant itself and the active substances contained are used in many industries such as medicine, industry, agriculture, and food. In medicine: it has the effect of dispersing blood stasis and promoting the circulation of the body, and promoting menstruation and relieving pain; experimental studies have shown that the active substances contained in C. longa have an effect in anti-tumor, anti-inflammatory, antibacterial, antioxidant, regulating cardiovascular function, and regulating blood system functions. In industry: the extract of C. longa can be used as natural dyes and cosmetic raw materials. In the food industry: it can be used as condiment and food coloring, etc. In agriculture: it's extract has a good repelling effect on Tribolium castaneum, Sitophilus zeamais, Callosobruchus chinensis, etc., and has an inhibitory effect on the growth of Schistocerca gregaria and nymphs of Pyrrhocoridae. Studies have also shown that 3% of neem oil and turmeric powder extracts together can effectively control Sitobion avenae and, Rhopalosiphum padi in wheat.

In the research and development of plant-derived pesticides, adjuvants are often added to formulate them into stable, safe, and efficient pesticide preparations. Currently, the main pesticide formulations include the following types: suspension concentrate (SC), emulsifiable concentrate (EC), microemulsion (ME), emulsion oil in water (EW), wettable powder (WP), water-dispersible granule (WDG, also known as dry flowable), aqueous solution (AS), granule (GR), and microcapsule suspension (CS). For plant-derived pesticide formulations, much research focuses on environmentally friendly formulations such as microemulsions, microcapsule suspensions, and water-dispersible granules. Meanwhile, in the development of emulsifiable concentrates, efforts are directed toward replacing highly polluting adjuvants like xylene with novel eco-friendly adjuvants to achieve an upgraded EC formulation.

### SUMMARY

The present application provides a method for preparing both a Curcuma longa rhizome extract (C. longa rhizome extract) and it's emulsifiable concentrate, and use thereof in the prevention and treatment of plant powdery mildew.

In a first aspect, the present application provides a method for preparing a C. longa rhizome extract, and the method comprises:
(1) drying and crushing a raw material of C. longa rhizome, and performing extraction with an aqueous ethanol solution to obtain an extract solution;
(2) concentrating the extract solution, and then performing extraction with an organic solvent to obtain an aqueous-phase product and an oil-phase product; and
(3) subjecting the oil-phase product to molecular distillation to remove turmeric oleoresin to obtain the C. longa rhizome extract.

The present application employs a specific preparation process to produce the C. longa rhizome extract. The method involves sequentially subjecting a raw material of C. longa rhizome to drying and crushing, ethanol extraction, further extraction, and molecular distillation. This preparation method demonstrates strong operational feasibility and is suitable for scaled-up industrial production.

The C. longa rhizome extract prepared through the present application appears as a pale yellow, flowable, homogeneous and transparent liquid with a mild ginger-like aroma. Experimental results indicate that the C. longa rhizome extract has exceptional efficacy in both preventing and treating plant powdery mildew disease, particularly effective against Leguminosae, Rosaceae, and Vitaceae plant species. Compared to synthetic chemical pesticides, the C. longa rhizome extract prepared through the present application offers significant advantages: natural origin with low toxicity, no environmental accumulation to cause environmental pollution, and degrades rapidly. Furthermore, compared to single-component synthetic chemical pesticides, the C. longa rhizome extract prepared in the present application has a complex composition. The control of plant powdery mildew is achieved through the synergistic interaction of multiple active constituents working together, while some other non-active components also play auxiliary roles. Thus, the target is less likely to develop resistance.

The C. longa rhizome extract prepared through the present application exhibits excellent stability with prolonged storage duration. Furthermore, it demonstrates remarkable environmental friendliness, showing low toxicity to species in terrestrial environments such as birds, bees, and silkworms in application environments. These characteristics indicate broad application prospects.

Preferably, a concentration of the aqueous ethanol solution is 55-95%, for example, 55%, 60%, 65%, 68%, 70%, 72%, 75%, 78%, 80%, 82%, 85%, 90%, or 95%. Other specific values between the numerical range are also selectable, which are not recited here. Further preferably, the concentration is 65-85%.

The concentration of the aqueous ethanol solution is specifically selected to be 55-95%, because the C. longa rhizome extract prepared under this concentration range demonstrates significantly enhanced efficacy in preventing and treating plant powdery mildew, particularly for Leguminosae, Rosaceae, and Vitaceae species. A further preferred concentration range is 65-85%.

Preferably, a solid-to-liquid ratio of the raw material of C. longa rhizome to the aqueous ethanol solution is (20-150) g/L, for example, 20 g/L, 25 g/L, 30 g/L, 35 g/L, 40 g/L, 45 g/L, 50 g/L, 55 g/L, 60 g/L, 65 g/L, 70 g/L, 80 g/L, 100 g/L, or 150 g/L. Other specific values between the numerical range are also selectable, which are not recited here. Further preferably, the solid-to-liquid ratio is (30-70) g/L.

The solid-to-liquid ratio of the raw material of C. longa rhizome to the aqueous ethanol solution is specifically selected to be (20-150) g/L, because the C. longa rhizome extract prepared under this ratio demonstrates significantly enhanced efficacy in preventing and treating plant powdery mildew, particularly for Leguminosae, Rosaceae, and Vitaceae species. A further preferred ratio range is (30-70) g/L.

Preferably, the extraction is performed at a temperature of 10-60° C., for example, 10° C., 15° C., 20° C., 25° C., 30° C., 35° C., 40° C., 45° C., 50° C. or 60° C. Other specific values between the numerical range are also selectable, which are not recited here. Further preferably, the temperature is 15-30° C.

Preferably, the extraction is performed for a period of 24-96 h, for example, 24 h, 28 h, 30 h, 35 h, 40 h, 45 h, 48 h, 60 h, 72 h, or 96 h. Other specific values between the numerical range are also selectable, which are not recited here. Further preferably, the period is 30-50 h.

The preferred extraction temperature and duration are set at 10-60° C. and 24-96 h because either exceeding these ranges (higher/lower temperature or longer/shorter duration) would adversely affect the powdery mildew prevention and control efficacy of the C. longa rhizome extract. The optimal ranges are 15-30° C. and 30-50 h.

Preferably, the organic solvent comprises any one or a combination of at least two of n-hexane, petroleum ether, cyclohexane, isooctane, trifluoroacetic acid, trimethylpentane, cyclopentane, heptane, butyryl chloride, trichloroethylene, carbon tetrachloride, propyl ether, or toluene.

The extraction process involved in the present application employs a low-polarity organic solvent, with the aforementioned types being particularly preferred, as they significantly enhance the powdery mildew control performance of the resulting C. longa rhizome extract.

Preferably, the molecular distillation is performed under a pressure condition of 0.1-10 Pa, for example, 0.1 Pa, 0.5 Pa, 1 Pa, 1.5 Pa, 2 Pa, 2.5 Pa, 3 Pa, 3.5 Pa, 4 Pa, or 5 Pa. Other specific values between the numerical range are also selectable, which are not recited here. Further preferably, the pressure is 0.1-5 Pa.

Preferably, the molecular distillation is performed at a temperature of 100-150° C., for example, 100° C., 110° C., 115° C., 120° C., 125° C., 130° C., 135° C., 140° C., 145° C., or 150° C. Other specific values between the numerical range are also selectable, which are not recited here. Further preferably, the temperature is 110-130° C.

The preferred temperature and pressure of the molecular distillation are set at 100-150° C. and 0.1-10 Pa because either exceeding these ranges (higher/lower temperature or higher/lower pressure) would adversely affect the powdery mildew prevention and control efficacy of the C. longa rhizome extract. The optimal ranges are 110-130° C. and 0.1-5 Pa.

In a second aspect, the present application provides a C. longa rhizome extract prepared by the method for a C. longa rhizome extract as described in the first aspect.

The C. longa rhizome extract presents as a pale yellow, flowable, homogeneous and transparent liquid with a mild ginger-like aroma. It has exceptional efficacy in both preventing and treating plant powdery mildew disease, particularly effective against Leguminosae, Rosaceae, and Vitaceae plant species, can degrade rapidly in the environment without causing environmental pollution while not easy to develop resistance and facilitate sustainable development, and exhibits stable physical and chemical properties with prolonged storage duration; furthermore, it demonstrates remarkable environmental friendliness, showing low toxicity to species such as birds, bees, and silkworms in application environments. These characteristics indicate broad application prospects.

In a third aspect, the present application provides an emulsifiable concentrate formulation of C. longa rhizome extract. Based on the mass percentage content, a component of the emulsifiable concentrate formulation of C. longa rhizome extract comprises 30-70% of the C. longa rhizome extract prepared by the preparation method as described in the first aspect, 10-35% of an emulsifier, and 15-50% of a solvent.

In the present application, components of the C. longa rhizome extract, the emulsifier, and the solvent in a specific mass ratio are compounded to prepare novel emulsifiable concentrate formulation for preventing and controlling plant powdery mildew, wherein the C. longa rhizome extract serves as the active ingredient. The formulation features a simple preparation process and user-friendly application, while demonstrating exceptional thermal stability across both high and low temperatures, which can ensure the C. longa rhizome extract maintains prolonged and consistent efficacy in powdery mildew prevention and control. Compared to synthetic chemical pesticides, the extract offers significant advantages: it is naturally derived and of low toxicity, does not accumulate in or pollute the environment, and degrades rapidly. Furthermore, compared to single-component synthetic pesticides, the C. longa rhizome extract has a complex composition. Its efficacy is a result of the synergistic action of multiple active components, supported by auxiliary effects from other components. This multi-target mechanism significantly reduces the risk of target pathogens developing resistance.

A mass percentage content of the C. longa rhizome extract may be 30%, 35%, 40%, 45%, 50%, 55%, 60%, 65%, or 70%; a mass percentage content of the emulsifier may be 10%, 15%, 20%, 25%, 30%, or 35%; a mass percentage content of the solvent may be 15%, 20%, 25%, 30%, 35%, 40%, 45%, or 50%. Other specific values between the numerical ranges are also selectable, which are not recited here.

Preferably, based on the mass percentage content, a component of the emulsifiable concentrate formulation of C. longa rhizome extract comprises: 40-60% of the C. longa rhizome extract prepared by the preparation method as described in the first aspect, 20-30% of the emulsifier, and 15-35% of the solvent.

In a case where the C. longa rhizome extract, the emulsifier, and the solvent are combined at the aforementioned preferred mass ratio, the resulting product demonstrates superior stability under high-temperature, low-temperature, and room-temperature conditions, which can ensure the C. longa rhizome extract to have a prolonged and consistent efficacy in powdery mildew prevention and control.

Preferably, the solvent comprises any one or a combination of at least two of methyl oleate, soybean oil, corn oil, rapeseed oil, or pine-based oil.

In the present application, the environmentally friendly solvent is employed, which exhibits excellent biodegradability and low pollution potential, thereby minimizing environmental contamination and enhancing the applicability of the emulsifiable concentrate formulation product.

Preferably, the emulsifier comprises a non-ionic emulsifier and an anionic emulsifier.

Preferably, the non-ionic emulsifier comprises any one or a combination of at least two of polyoxyethylene tristyrylphenol ether, polyoxyethylene sorbitan trioleate, tristyrylphenol ethoxylate-propoxylate, or castor oil polyglycol ether ester.

Preferably, the anionic emulsifier is selected from any one or a combination of at least two of a diphenyl sulfonate, an α-olefin sulfonate, a lignosulfonate, a sulfonate of ethoxylated alkylphenol, a sulfonate of alkoxylated arylphenol, a sulfonate of condensed naphthalene, a sulfonate of dodecylbenzene or tridecylbenzene, a sulfonate or a sulfosuccinate of naphthalene or alkylnaphthalene.

In the present application, the formulation of the emulsifier is optimized to achieve superior compatibility with both the solvent and the C. longa rhizome extract, thereby enhancing system stability and ensuring prolonged and consistent efficacy of the C. longa rhizome extract. The following composition is a preferred formulation of the emulsifier.

Preferably, based on the mass percentage content, the emulsifier comprises 30-40% of polyoxyethylene tristyrylphenol ether, 30-40% of polyoxyethylene sorbitan trioleate, and 25-35% of calcium dodecylbenzene sulfonate.

A mass percentage content of polyoxyethylene tristyrylphenol ether may be selected as 30%, 32%, 33%, 35%, 36%, 38%, or 40%; a mass percentage content of polyoxyethylene sorbitan trioleate may be selected as 30%, 32%, 33%, 35%, 36%, 38%, or 40%; a mass percentage content of calcium dodecylbenzene sulfonate may be selected as 25%, 27%, 28%, 30%, 32%, 35%, or 40%. Other specific values between the numerical ranges are also selectable, which are not recited here.

In the present application, through optimized selection of the solvent and the type of the emulsifier, the resulting emulsifiable concentrate formulation exhibits low toxicity, high safety, environmental friendliness, excellent stability, superior emulsification performance, and prolonged efficacy duration.

Preferably, a component of the emulsifiable concentrate formulation of C. longa rhizome extract further comprises any one or a combination of at least two of a synergist, a defoamer, or an adhesive.

The synergist may be, for example, 5-[2-(octylsulfinyl)propyl]-1,3-benzodioxole, azone, or JPC-2; the adhesive may be, for example, mineral oil, gelatin, or polyvinyl alcohol.

Preferably, a method for preparing the emulsifiable concentrate formulation of C. longa rhizome extract comprises: mixing a formulated amount of the emulsifier and the solvent, and performing a primary emulsification, then mixing with the C. longa rhizome extract and performing a secondary emulsification, to obtain the product.

Preferably, the emulsification is performed under stirring, and a rotational speed of the stirring is 3000-8000 rpm, for example, 3000 rpm, 4000 rpm, 5000 rpm, 6000 rpm, 7000 rpm, or 8000 rpm. Other specific values between the numerical range are also selectable, which are not recited here.

Preferably, the primary emulsification and the secondary emulsification are independently performed for a period of 3-10 min, for example, 3 min, 4 min, 5 min, 6 min, 7 min, 8 min, 9 min, or 10 min. Other specific values between the numerical range are also selectable, which are not recited here.

In a fourth aspect, the present application provides use of the C. longa rhizome extract prepared by the preparation method as described in the first aspect or the emulsifiable concentrate formulation of C. longa rhizome extract as described in the third aspect in preventing and controlling plant powdery mildew, wherein the plant comprises Leguminosae, Rosaceae, and Vitaceae plants.

In a fifth aspect, the present application provides a prevention and control method for plant powdery mildew, and the prevention and control method comprises: applying an effective dosage of the C. longa rhizome extract prepared by the preparation method as described in the first aspect or the emulsifiable concentrate formulation of C. longa rhizome extract as described in the third aspect to Leguminosas, Rosaceae, or Vitaceae plants.

Compared with the prior art, the present application has the following beneficial effects.
(1) In the present application, a specific preparation process is adopted to prepare the C. longa rhizome extract, that is, the method involves sequentially subjecting the raw material of C. longa rhizome to drying and crushing, ethanol extraction, further extraction, and molecular distillation. This preparation method demonstrates strong operational feasibility and is suitable for scaled-up industrial production.
(2) The prepared C. longa rhizome extract presents as a pale yellow, flowable, homogeneous and transparent liquid with a mild ginger-like aroma. The C. longa rhizome extract has exceptional efficacy in both preventing and treating plant powdery mildew disease, particularly effective against Leguminosas, Rosaceae, and Vitaceae plants, and it can degrade rapidly in the environment without causing environmental pollution while not easy to develop resistance and facilitate sustainable development. The extract exhibits stable physical and chemical properties with prolonged storage duration; furthermore, it demonstrates remarkable environmental friendliness, showing low toxicity to species such as birds, bees, and silkworms in application environments. These characteristics indicate broad application prospects in preventing and controlling plant powdery mildew and provide a new strategy for better prevention and control of plant powdery mildew. And,
(3) Furthermore, in the present application, components of the C. longa rhizome extract, the emulsifier, and the solvent in a specific mass ratio are compounded to prepare a novel emulsifiable concentrate formulation for preventing and controlling plant powdery mildew, wherein the C. longa rhizome extract serves as the active ingredient. The formulation features a simple preparation process and user-friendly application, while demonstrating superior stability under high-temperature, low-temperature, and room-temperature conditions, which ensures that the C. longa rhizome extract has a prolonged and consistent efficacy in powdery mildew prevention and control.

### DETAILED DESCRIPTION

In order to further elaborate the technical means adopted by the present application and its effects, the technical solution of the present application is further illustrated below in combination with the preferred embodiments of the present application, but the present application is not limited to the scope of the embodiments.

The raw material of dried C. longa rhizome involved in the following contents was purchased from Shanghai Traditional Chinese Medicine Market.

The composite emulsifier TERSPERSE 3016 (short as T-3016) involved in the following examples was a product purchased from Indorama Lab. (original Agrochemical Lab. of Hengsimai Chemistry Research & Development Center (Shanghai) Co., Ltd.); polyoxyethylene tristyrylphenol ether involved in the following examples was a product purchased from Yixing Jiateng Chemical Co., Ltd with a product No. 602 #; and polyoxyethylene sorbitan trioleate involved in the following examples was a product purchased from Jiangsu Haian Petrochemical Plant with a product No. T-85.

### Example 1

This example provides a C. longa rhizome extract prepared through the following method:
(1) a raw material of dried C. longa rhizome was crushed and then subjected to extraction by 75% aqueous ethanol solution (in a solid-to-liquid ratio of 50 g/L) at 20° C. for 48 h, to obtain an extract solution;
(2) the extract solution was concentrated and subjected to extraction by n-hexane, to obtain an aqueous-phase product and an oil-phase product; and
(3) the oil-phase product was subjected to molecular distillation under a pressure of 3 Pa and a temperature of 120° C. to remove turmeric oleoresin, to obtain the C. longa rhizome extract.

### Example 2

This example provides a C. longa rhizome extract prepared through the following method:
(1) a raw material of dried C. longa rhizome was crushed and then subjected to extraction by 85% aqueous ethanol solution (in a solid-to-liquid ratio of 30 g/L) at 15° C. for 50 h, to obtain an extract solution;
(2) the extract solution was concentrated and subjected to extraction by petroleum ether, to obtain an aqueous-phase product and an oil-phase product; and
(3) the oil-phase product was subjected to molecular distillation under a pressure of 1 Pa and a temperature of 130° C. to remove turmeric oleoresin, to obtain the C. longa rhizome extract.

### Example 3

This example provides a C. longa rhizome extract prepared through the following method:
(1) a raw material of dried C. longa rhizome was crushed and then subjected to extraction by 65% aqueous ethanol solution (in a solid-to-liquid ratio of 70 g/L) at 30° C. for 30 h, to obtain an extract solution;
(2) the extract solution was concentrated and subjected to extraction by cyclohexane, to obtain an aqueous-phase product and an oil-phase product; and
(3) the oil-phase product was subjected to molecular distillation under a pressure of 5 Pa and a temperature of 110° C. to remove turmeric oleoresin, to obtain the C. longa rhizome extract.

### Example 4

This example provides a C. longa rhizome extract, wherein the preparation method differs from Example 1 only in that the 75% aqueous ethanol solution was replaced with an equal amount of 55% aqueous ethanol solution. Other conditions were all the same.

### Example 5

This example provides a C. longa rhizome extract, wherein the preparation method differs from Example 1 only in that the 75% aqueous ethanol solution was replaced with an equal amount of 95% aqueous ethanol solution. Other conditions were all the same.

### Example 6

This example provides a C. longa rhizome extract, wherein the preparation method differs from Example 1 only in that the mass of the raw material of C. longa rhizome remained unchanged, while the solid-to-liquid ratio of 50 g/L was replaced with 20 g/L. Other conditions were all the same.

### Example 7

This example provides a C. longa rhizome extract, wherein the preparation method differs from Example 1 only in that the mass of the raw material of C. longa rhizome remained unchanged, while the solid-to-liquid ratio of 50 g/L was replaced with 150 g/L. Other conditions were all the same.

### Example 8

This example provides a C. longa rhizome extract, wherein the preparation method differs from Example 1 only in that the temperature of the molecular distillation was replaced from 120° C. to 100° C. Other conditions were all the same.

### Example 9

This example provides a C. longa rhizome extract, wherein the preparation method differs from Example 1 only in that the temperature of the molecular distillation was replaced from 120° C. to 150° C. Other conditions were all the same.

### Example 10

This example provides a C. longa rhizome extract, wherein the preparation method differs from Example 1 only in that the extracting agent was replaced from n-hexane to a mixed solvent of n-hexane and isooctane in a volume ratio of 2:1 with an equal volume.

### Example 11

This example provides a C. longa rhizome extract, wherein the preparation method differs from Example 1 only in that the extracting agent was replaced from n-hexane to isooctane with an equal volume.

### Application Example 1

This application example provides an emulsifiable concentrate formulation with C. longa rhizome extract as the active ingredient. The formulation of the emulsifiable concentrate is as follows: 50% of the C. longa rhizome extract prepared by Example 1, 30% of methyl oleate, 10% of Polysorbate80 (Tween 80), and 10% of calcium dodecylbenzene sulfonate.

### Application Examples 2-11

This application example provides ten emulsifiable concentrate formulations with C. longa rhizome extract as the active ingredient, wherein the formulation differs from Application Example 1 only in that the C. longa rhizome extract prepared by Example 1 was replaced with an equal amount of the C. longa rhizome extract prepared by Examples 2-11, respectively.

### Test Example 1

The C. longa rhizome extracts prepared by Examples 1-3 were subjected to characterizations of the following properties.
(1) Determination of the mass percentage of ar-turmerone (%): the sample was dissolved in anhydrous methanol and subjected to high-performance liquid chromatography separation with a mobile phase of methanol and water and a chromatographic column of C18 (4.6 mm×250 mm, 5 μm). The external standard method was used for the determination of ar-turmerone content in the sample at a UV absorbance of 242 nm.
(2) Determination of pH: referring to GB/T 1601-1993.
(3) Determination of moisture content (%): referring to 2.1.2 in GB/T 1600-2001.
(4) Determination of acetone insoluble (%): referring to GB/T 19138-2003.

The results are shown in Table 1.

TABLE 1

| Property | Example 1 | Example 2 | Example 3 |
|---|---|---|---|
| Appearance | Pale yellow | Pale yellow | Pale yellow |
| | oily liquid | oily liquid | oily liquid |
| Mass percentage of | 13.2 | 12.6 | 11.8 |
| ar-turmerone (%) | | | |
| pH value | 4.9 | 5.1 | 4.7 |
| Moisture content (%) | 0.1 | 0.1 | 0.2 |
| Acetone insoluble (%) | 0.02 | 0.01 | 0.03 |

As can be seen from the data in Table 1: the C. longa rhizome extract prepared by the preparation process of the present application has a high content of ar-turmerone, which serves as one of the active ingredients; a weakly acidic pH, which could ensure active ingredient stability and reduce decomposition to minimize packaging corrosion; a low moisture content of less than 0.5%, which could effectively prevent decomposition of active components in the product; and acetone insoluble of less than 0.5%, indicating a high product purity.
(5) The C. longa rhizome extract prepared by Example 1 was subjected to ar-turmerone hydrolysis testing according to the Chinese standard GB/T 31270.2-2014 Test guidelines on environmental safety assessment for chemical pesticides—Part 2: Hydrolysis. The liquid chromatography was adopted to determine ar-turmerone with a chromatographic column of Waters Xbridge™ C₈ 4.6×250 mm, 5 μm, a mobile phase of acetonitrile and water (60:40 v/v), an injection volume of 20 μL, and determined by an UV detector at 242 nm.

Test results: under constant temperature of 25° C. and dark conditions, the degradation half-life of ar-turmerone was 9.5 days (pH 4), 9.56 days (pH 7), and 8.27 days (pH 9), respectively; under constant temperature of 50° C. and dark conditions, the degradation half-life of ar-turmerone was 0.819 days (pH 4), 0.837 days (pH 7), 0.847 days (pH 9), respectively. According to the classification standard of pesticide degradability in hydrolysis in Chinese standards, the degradability grade of ar-turmerone at pH 4, pH 7, and pH 9 was “Grade I (readily degradable)”.
(6) The C. longa rhizome extract prepared by Example 1 was subjected to ar-turmerone soil aerobic degradation test according to the Chinese standard GB/T 31270.1-2014 Test guidelines on environmental safety assessment for chemical pesticides—Part 1: Transformation in soils. The liquid chromatography was adopted to determine ar-turmerone with a chromatographic column of Waters Xbridge™ C₈ 4.6×250 mm, 5 μm, a mobile phase of acetonitrile and water (60:40 v/v), and determined by an UV detector at 242 nm.

Test results: under aerobic conditions, the degradation half-life of ar-turmerone in soils was 2.75 days in red soil, 3.57 days in black soil, 3.09 days in paddy soil, and 3.41 days in aquic brown soil. According to the classification standard of pesticide degradability in soils in Chinese standards, the degradability grade of ar-turmerone in the four soils was “Grade I (readily degradable)”.

### Test Example 2

The C. longa rhizome extracts prepared by Examples 1-3 were subjected to toxicological characterization:
(1) determination of acute oral median lethal dose in male and female SD rats: the test was performed according to the method referring to GB/T 15670.4-2017 Toxicological test methods for pesticides registration—Part 4;
(2) determination of acute dermal median lethal dose in male and female SD rats: the test was performed according to the method referring to GB/T 15670.5-2017 Toxicological test methods for pesticides registration—Part 5;
(3) determination of acute inhalation median lethal concentration in male and female SD rats: the test was performed according to the method referring to GB/T 15670.6-2017 Toxicological test methods for pesticides registration—Part 6;
(4) eye irritation test in New Zealand White rabbits: the test was performed according to the method referring to GB/T 15670.8-2017 Toxicological test methods for pesticides registration—Part 8;
(5) skin irritation test in New Zealand White rabbits: the test was performed according to the method referring to GB/T 15670.7-2017 Toxicological test methods for pesticides registration—Part 7; and
(6) skin sensitization test in Hartley guinea pigs: the test was performed according to the method referring to GB/T 15670.9-2017 Toxicological test methods for pesticides registration—Part 9.

The results are shown in Table 2.

TABLE 2

| Property | Example 1 | | Example 2 | | Example 3 | |
|---|---|---|---|---|---|---|
| Acute oral in female rats LD50 | >5000 | mg/kg | >5000 | mg/kg | >5000 | mg/kg |
| Acute oral in male rats LD50 | >5000 | mg/kg | >5000 | mg/kg | >5000 | mg/kg |
| Acute dermal in female rats LD50 | >2000 | mg/kg | >2000 | mg/kg | >2000 | mg/kg |
| Acute dermal in male rats LD50 | >2000 | mg/kg | >2000 | mg/kg | >2000 | mg/kg |
| Acute inhalation in female rats LD50 | >5000 | mg/m³ | >5000 | mg/m³ | >5000 | mg/m³ |
| Acute inhalation in male rats LD50 | >5000 | mg/m³ | >5000 | mg/m³ | >5000 | mg/m³ |

| | | | |
|---|---|---|---|
| Eye irritation in New | Recovered | Recovered | Recovered |
| Zealand White rabbits | within 36 h | within 38 h | within 40 h |
| Skin irritation in New | 0.7 | 0.8 | 0.9 |
| Zealand White rabbits | | | |
| Sensitization rate in | 0% | 0% | 0% |
| Hartley guinea pigs | | | |

As can be seen from the data in Table 2, the C. longa rhizome extracts involved in the present application has high safety, slightly toxic, low irritation, and weak allergenicity.

### Test Example 3

The C. longa rhizome extracts prepared by Examples 1-3 were subjected to environmental impact assessment.

All the environmental impact tests were conducted by Shenyang Research Institute of Chemical Industry with the following results:
(1) Acute oral toxicity in quails: according to the method referring to GB/T 31270.9-2014 Test guidelines on environmental safety assessment for chemical pesticides—Part 9 (female for 48 h);
(2) Acute oral toxicity in honeybees: according to the method referring to GB/T 31270.10-2014 Test guidelines on environmental safety assessment for chemical pesticides—Part 10 (female for 48 h);
(3) Acute contact toxicity in honeybees: according to the method referring to GB/T 31270.10-2014 Test guidelines on environmental safety assessment for chemical pesticides—Part 10 (male for 48 h); and
(4) Acute toxicity in silkworms: according to the method referring to GB/T 31270.11-2014 Test guidelines on environmental safety assessment for chemical pesticides—Part 11 (for 48 h).

The results are shown in Table 3.

TABLE 3

| Property | Example 1 | | Example 2 | | Example 3 | |
|---|---|---|---|---|---|---|
| Acute oral toxicity in quails LD₅₀ | >2000 | mg/kg | >2000 | mg/kg | >2000 | mg/kg |
| Acute oral toxicity in honeybees LD₅₀ | >99.6 μg/each | | >99.0 μg/each | | >99.1 μg/each | |
| | honeybee | | honeybee | | honeybee | |
| Acute contact toxicity in honeybees LD₅₀ | >100 μg/each | | >99.5 μg/each | | >99.0 μg/each | |
| | honeybee | | honeybee | | honeybee | |
| Acute toxicity in silkworms LC₅₀ | >534 | mg/L | >483 | mg/L | >508 | mg/L |

As can be seen from the data in Table 3, the C. longa rhizome extracts involved in the present application are environmentally friendly and have low toxicity to birds, honeybees, silkworms, and other organisms in the environment.

### Test Example 4

The emulsifiable concentrate formulations prepared by Application Examples 1-11 were subjected to tests for the prevention and control of pea powdery mildew.
(1) Cultivation of pea seedlings: Pea seeds (variety: ‘Sweet Crisp’) were soaked in a Petri dish with water for 24 h at room temperature, then the water was drained, and moistened absorbent cotton was placed in the dish, and pea seeds were distributed evenly in the dish. The cotton was kept moist by daily watering. After approximately one week, when the pea seedlings reached a height of 2-3 cm, they were transplanted into small pots and watered every two days. Pea seedlings were selected for experiment when the first true leaf was fully expanded and the second true leaf had begun to unfold, ensuring they were healthy and of uniform size.
(2) Preparation of Erysiphe pisi DC. spore suspension: the spray method was used to inoculate the conidia suspension of the pathogen to pea seedlings, thereby it is necessary to prepare a spore suspension with an appropriate concentration, and the method is as follows:
(2.1) purified water was filled into a spray bottle, freshly developed powdery mildew spots on infected leaves were selected, and the spores were washed off into a clean beaker by gentle spraying; and
(2.2) the collected spore suspension was uniformly mixed, and one droplet was taken on a microscope slide and examined by a microscope to assess spore turgidity and morphology and observe the number of spores in the field of view at a magnification of 15*10× to check if it met the requirements. Requirements on the spore suspension: spores were plump in morphology to ensure the viability; 20-30 spores per field of view at the magnification of 15*10×, which was the optimal range; and the spore suspension needed to be used within 2 h from preparation to ensure the viability of spores.
(3) Inoculation of Erysiphe pisi DC.:
(3.1) the prepared spore suspension was uniformly sprayed onto pea leaves;
(3.2) the inoculated pea seedlings were transferred to a growth chamber, and the remaining spore suspension was sprayed inside the chamber to create a high humidity environment, then the chamber was covered and incubated at about 25° C. for 24 h; and
(3.3) after 24 h, the chamber was uncovered and the pea seedlings were taken out, and after the leaves were air-dried, the pea seedlings could be subjected to chemical treatment.
(4) Application method: (4.1) for each group, 0.1 mL emulsifiable concentrate formulation was diluted 200-fold with deionized water, filled into a spray bottle, and labeled for later use;
(4.2) preparation of agent for adjuvant-control group: according to the preparation formula, the content of the C. longa rhizome extract was replaced with water, and then an adjuvant solution was prepared with the same concentration of the adjuvant contained in the formulation; 0.1 mL the adjuvant solution was diluted 200-fold with water, filled into a spray bottle, and labeled for later use;
(4.3) preparation of agent for positive control group: fungicide tebuconazole suspension concentrate of 430 g/L was diluted 2000-fold with water, filled into a spray bottle, and labeled for later use;
(4.4) preparation of blank control group: deionized water was filled into a spray bottle, and labeled for later use;
(4.5) spraying: the inoculated pea seedlings were cultivated for 24 h, and treated with agents (4 replicates per treatment); leaves were sprayed with the corresponding agent evenly, and the standard was to cover the complete surface of the leaves;
(4.6) cultivation: the agent-treated pea seedlings were cultivated at about 25° C. and humidity around 70%, and watered every 2 days; and
(4.7) observation: the phytotoxicity symptom was observed 24 h and 5 days after the spraying, and agent causing severe phytotoxicity symptom was discarded according to the phytotoxicity symptom; the disease incidence of the remained agents was counted six days later to calculate the prevention and control effect, and the prevention and control changes were observed and recorded for several consecutive days.
(5) Efficacy evaluation:
10 plants were evaluated per group of samples, and all leaves were assessed per plant.

The disease rating scale was as follows:
Grade 0: no lesions;
Grade 1: ≤55% leaf coverage with lesions;
Grade 3: 6-15% leaf coverage;
Grade 5: 16-25% leaf coverage;
Grade 7: 26-50% leaf coverage; and
Grade 9: ≥51% leaf coverage.

$$Disease index = [ \text{} \sum ( Number of diseased leaves at each grade \times Corresponding grade value ) ] \text{} / ( Total number of leaves assessed \times highest desease index \times 9 ) \times 100$$

$$Control efficacy \% = ( disease index of control group after administraion - disease index of other group after administration ) / disease index of control group after administraion \times 100$$

The data of control efficacy is shown in Table 4.

TABLE 4

| | Control |
|---|---|
| Group | efficacy (%) |
| Application Example 1 | 79.82 |
| Application Example 2 | 78.44 |
| Application Example 3 | 77.58 |
| Application Example 4 | 72.61 |
| Application Example 5 | 75.36 |
| Application Example 6 | 73.37 |
| Application Example 7 | 74.67 |
| Application Example 8 | 77.57 |
| Application Example 9 | 73.44 |
| Application Example 10 | 81.55 |
| Application Example 11 | 72.63 |
| Adjuvant-control group | 0 |
| Positive control group | 83.81 |
| Blank control group | 0 |

As can be seen from the data in Table 4, the C. longa rhizome extracts involved in the present application have excellent efficacy of pea powdery mildew prevention and control, wherein the preparation conditions of the C. longa rhizome extract also affect this efficacy.

### Test Example 5

The emulsifiable concentrate formulations prepared by Application Examples 1-3 were subjected to field efficacy trials against grape powdery mildew.
(1) Test target and crop variety
Grape variety: red globe; target pathogen: grape powdery mildew
(2) Test agents: the Emulsifiable Concentrate Formulations from Application Examples 1-3 Diluted 500-Fold With Water for Later Use
agent for positive control: 325 g/L azoxystrobin SC from Zhejiang Tianfeng Bioscience Co., Ltd. with a registration No.: PD20172823 and a batch No.: 20210318, diluted 1000 times for later use; simultaneously, a water-only control group was set.
(3) Trial location: Zengjiaying Village, Binchuan County, Dali, Yunnan, China
block arrangement: the experiment set up 5 processes, each treatment had 4 block repeats, and each block repeated an area of 15 m².
(4) Application method: a 20-type knapsack electric sprayer from Zhengzhou Xinxiu Agricultural Machinery Co., Ltd. was used for spraying the formulations prepared according to the experimental design and sprayed uniformly onto plants across all treatments until runoff;
The treatments application were conducted when the initial disease onset stage (i.e., when sporadic lesions appeared on lower leaves) twice at 8-day intervals, and the spray dates were recorded.
(5) Assessment method
Five points were assessed per treatment group, 2 plants were included in each point, and all leaves were assessed per plant.

The disease rating scale was as follows:
Grade 0: no lesions;
Grade 1: ≤5% leaf coverage with lesions;
Grade 3: 6-10% leaf coverage;
Grade 5: 11-20% leaf coverage;
Grade 7: 21-40% leaf coverage; and
Grade 9: ≥40% leaf coverage.
(6) Calculation method for efficacy

$$Disease index = [ \text{} \sum ( Number of diseased leaves at each grade \times Corresponding grade value ) ] \text{} / ( Total number of leaves assessed \times 9 ) \times 100$$

$$Control efficacy \% = [ 1 - disease index of treament block / disease index of control group ) ] \times 100$$

The results were shown in Table 5.

TABLE 5

| | Control | Positive | Application | Application | Application |
|---|---|---|---|---|---|
| Assessment date | group | control group | Example 1 | Example 2 | Example 3 |
| Disease index after | 0.075 | 0.038 | 0.025 | 0.029 | 0.030 |
| 8 days of the first | | | | | |
| administration | | | | | |
| Efficacy after 8 | / | 61.47% | 72.16% | 65.43% | 64.42% |
| days of the first | | | | | |
| administration | | | | | |
| Disease index after | 0.101 | 0.047 | 0.027 | 0.031 | 0.029 |
| 8 days of the second | | | | | |
| administration | | | | | |
| Efficacy after 8 | / | 64.15% | 78.22% | 72.63% | 70.82% |
| days of the second | | | | | |
| administration | | | | | |

As can be seen from the data in Table 5, The emulsifiable concentrate formulations prepared by Application Examples 1-3 have excellent efficacy of grape powdery mildew prevention and control, wherein the preparation conditions of the wherein the preparation conditions of the C. longa rhizome extract also affect this efficacy.

### Test Example 6

The emulsifiable concentrate formulations prepared by Application Examples 1-3 were subjected to field efficacy trials against rose powdery mildew.
(1) Test target and crop variety
Rose variety: awakening; target pathogen: rose powdery mildew
(2) Test agents: the emulsifiable concentrate formulations from Application Examples 1-3 diluted 500-fold with water for later use;
agent for positive control: 25% bupirimate ME from Xi'an MTI Co., Ltd. with a registration No.: PD20190149 and a batch No.: 20201023018, diluted 1000 times for later use; simultaneously, a water-only control group was set.
(3) Trial location: Goujie Town, Yiliang County, Kunming, Yunnan, China
block arrangement: the experiment set up 5 processes, each treatment had 4 block repeats, and each block repeated an area of 15 m².
(4) Application method: a 20-type knapsack electric sprayer from Zhengzhou Xinxiu Agricultural Machinery Co., Ltd. was used for spraying the formulations prepared according to the experimental design and sprayed uniformly onto plants across all treatments until runoff;
Application were conducted when the initial disease onset stage (i.e., when sporadic lesions appeared on lower leaves) once, and the application dates were recorded.
(5) Assessment method
Five points were assessed per treatment group, 2 plants were included in each point, and all leaves were assessed per plant.

The disease rating scale was as follows:
Grade 0: no lesions;
Grade 1: ≤5% leaf coverage with lesions;
Grade 3: 6-10% leaf coverage;
Grade 5: 11-20% leaf coverage;
Grade 7: 21-40% leaf coverage; and
Grade 9: ≥40% leaf coverage.
(6) Calculation method for efficacy

$$Disease index = [ \text{} \sum ( Number of diseased leaves at each grade \times Corresponding grade value ) ] \text{} / ( Total number of leaves assessed \times 9 ) \times 100$$

$$Control efficacy \% = [ 1 - disease index of treament block / disease index of control group ) ] \times 100$$

The results were shown in Table 6.

TABLE 6

| | Disease index after | Control efficacy after |
|---|---|---|
| | 7 days of the first | 7 days of the first |
| Group | administration | administration |
| Control group | 0.054 | / |
| Positive control group | 0.014 | 67.36% |
| Application Example 1 | 0.009 | 72.59% |
| Application Example 2 | 0.015 | 63.42% |
| Application Example 3 | 0.017 | 61.74% |

As can be seen from the data in Table 6, the emulsifiable concentrate formulations prepared by Application Examples 1-3 have excellent efficacy of rose powdery mildew prevention and control, wherein the preparation conditions of the C. longa rhizome extract also affect this efficacy.

### Application Example 12

This application example provides an emulsifiable concentrate formulation of C. longa rhizome extract, with the following composition: 50% of the C. longa rhizome extract prepared by Example 1, 30% of methyl oleate, and 20% of a composite emulsifier T-3016 (composed of 30% polyoxyethylene tristyrylphenol ether, 38% polyoxyethylene sorbitan trioleate, and 32% calcium dodecylbenzene sulfonate).

The preparation method is as follows: a formulated amount of the composite emulsifier T-3016 and methyl oleate were mixed and subjected to primary emulsification at 5000 rpm for 5 min, then mixed with the C. longa rhizome extract and subjected to secondary emulsification at 5000 rpm for 5 min, to obtain the product.

### Application Example 13

This application example provides an emulsifiable concentrate formulation of C. longa rhizome extract, with the following composition: 50% of the C. longa rhizome extract prepared by Example 1, 25% of soybean oil, and 25% of a composite emulsifier T-3016 (composed of 30% polyoxyethylene tristyrylphenol ether, 38% polyoxyethylene sorbitan trioleate, and 32% calcium dodecylbenzene sulfonate).

The preparation method isas follows: a formulated amount of the composite emulsifier and soybean oil were mixed and subjected to primary emulsification at 7000 rpm for 3 min, then mixed with the C. longa rhizome extract and subjected to secondary emulsification at 3000 rpm for 10 min, to obtain the product.

### Application Example 14

This application example provides an emulsifiable concentrate formulation of C. longa rhizome extract, with the following composition: 50% of the C. longa rhizome extract prepared by Example 1, 20% of corn oil, and 30% of a composite emulsifier T-3016 (composed of 30% polyoxyethylene tristyrylphenol ether, 38% polyoxyethylene sorbitan trioleate, and 32% calcium dodecylbenzene sulfonate).

The preparation method is as follows: a formulated amount of the composite emulsifier and corn oil were mixed and subjected to primary emulsification at 3000 rpm for 10 min, then mixed with the C. longa rhizome extract and subjected to secondary emulsification at 6000 rpm for 8 min, to obtain the product.

### Application Examples 15 and 16

This application example provides two emulsifiable concentrate formulations of C. longa rhizome extract, wherein the composition differs from Application Example 12 only in that the C. longa rhizome extract prepared by Example 1 was replaced with an equal amount of the C. longa rhizome extract prepared by Examples 4 and 5, respectively. Other components and contents were the same.

### Application Examples 17

This application example provides an emulsifiable concentrate formulation of C. longa rhizome extract, wherein the composition differs from Application Example 12 only in that the composite emulsifier T-3016 was replaced with another composite emulsifier (composed of 50% Tween 80 and 50% calcium dodecylbenzene sulfonate). Other components and contents were the same.

### Application Examples 18

This application example provides an emulsifiable concentrate formulation of C. longa rhizome extract, wherein the composition differs from Application Example 12 only in that the composite emulsifier T-3016 was replaced with another composite emulsifier (composed of 48% polyoxyethylene tristyrylphenol ether and 52% polyoxyethylene sorbitan trioleate). Other components and contents were the same.

### Application Examples 19

This application example provides an emulsifiable concentrate formulation of C. longa rhizome extract, wherein the composition differs from Application Example 12 only in that the composite emulsifier T-3016 was replaced with a single emulsifier (calcium dodecylbenzene sulfonate). Other components and contents were the same.

### Test Example 7

The emulsifiable concentrate formulations of C. longa rhizome extract prepared by Application Examples 12-14 were subjected to characterizations of the following properties.
(1) Determination of the mass percentage of ar-turmerone (%): the sample was dissolved in anhydrous methanol and subjected to high-performance liquid chromatography separation with a mobile phase of methanol and water and a chromatographic column of C18 (4.6 mm×250 mm, 5 μm). The external standard method was used for the determination of ar-turmerone content in the sample at a UV absorbance of 242 nm.
(2) Emulsion stability evaluation: emulsion stability is a critical parameter specific to emulsifiable concentrates, directly impacting product performance. The sample was diluted 200-fold with standard hard water, and the test was conducted according to GB/T 1603-2001: stability of the emulsion was qualified if no oil slick (upper layer) or oil sediment (bottom) was observed in the measuring cylinder.
(3) Foaming persistence (1 min) evaluation: the addition of emulsifiers may produce a certain amount of foam during the dispersion of the product in water, and the amount of foam directly affects the application efficiency of the product. Thereby, the amount of foam needs to be controlled. The evaluation was conducted according to GB/T 28137-2011: foam volume ≤60 mL after 1 min indicated compliance.
(4) Low-temperature stability evaluation: products sometimes need to be stored and transported under relatively cold conditions, which requires that the product still maintains a good appearance at lower temperatures without precipitation. The evaluation was conducted according to GB/T 19137-2003 (Section 2.1): the product was stored at 2° C. for 7 days and was qualified if the volume of the precipitates ≤0.3 mL.
(5) Thermal storage stability evaluation: thermal storage stability is an indicator for testing the shelf life of pesticides. The thermal storage stability test is performed to quickly age the product by heating, indicating whether the product has good storage stability at room temperature. The evaluation was conducted according to GB/T 19136-2003 (Section 2.1): the product was stored at 55° C. for 14 days. According to the review requirements of the pesticide calibration institute and the actual data of the product storage test, it is stipulated that the mass percentage content and mass concentration of ar-turmerone in the emulsifiable concentrate of C. longa extract after the thermal storage should not be less than 95% measured before the thermal storage, such the stability of the emulsion meets the standard requirements.

The results are shown in Table 7.

TABLE 7

| | Application | Application | Application |
|---|---|---|---|
| Property | Example 12 | Example 13 | Example 14 |
| Appearance | Yellow, | Yellow, | Yellow, |
| | flowable, | flowable, | flowable, |
| | homogeneous, | homogeneous, | homogeneous, |
| | transparent | transparent | transparent |
| | liquid | liquid | liquid |
| Mass percentage of | 6.5% | 6.5% | 6.5% |
| ar-turmerone (%) | | | |
| Emulsion stability | Qualified | Qualified | Qualified |
| Foaming | 46 mL | 52 mL | 50 mL |
| persistence | | | |
| Low-temperature | Qualified | Qualified | Qualified |
| stability | | | |
| Thermal storage | Qualified | Qualified | Qualified |
| stability | | | |

As can be seen from the data in Table 7, the emulsifiable concentrate formulations of C. longa rhizome extract involved in the present application have excellent emulsion stability, thermal storage stability, and low-temperature stability, enabling the C. longa rhizome extract to exert its effects more stably and persistently on preventing and treating powdery mildew.

### Test Example 8

The emulsifiable concentrate formulations of C. longa rhizome extract prepared by Application Examples 12-14 were subjected to toxicological characterization:
(1) Determination of acute oral median lethal dose in male and female SD rats: the test was performed according to the method referring to GB/T 15670.4-2017 Toxicological test methods for pesticides registration—Part 4;
(2) Determination of acute dermal median lethal dose in male and female SD rats: the test was performed according to the method referring to GB/T 15670.5-2017 Toxicological test methods for pesticides registration—Part 5;
(3) Determination of acute inhalation median lethal concentration in male and female SD rats: the test was performed according to the method referring to GB/T 15670.6-2017 Toxicological test methods for pesticides registration—Part 6;
(4) Eye irritation test in New Zealand White rabbits: the test was performed according to the method referring to GB/T 15670.8-2017 Toxicological test methods for pesticides registration—Part 8; and
(5) Skin sensitization test in Hartley guinea pigs: the test was performed according to the method referring to GB/T 15670.9-2017 Toxicological test methods for pesticides registration—Part 9.

The results are shown in Table 8.

TABLE 8

| | Application | | Application | | Application | |
|---|---|---|---|---|---|---|
| Property | Example 12 | | Example 13 | | Example 14 | |
| Acute oral in female rats LD50 | >5500 | mg/kg | >5500 | mg/kg | >5500 | mg/kg |
| Acute oral in male rats LD50 | >7000 | mg/kg | >7000 | mg/kg | >7000 | mg/kg |
| Acute dermal in female rats LD50 | >2000 | mg/kg | >2000 | mg/kg | >2000 | mg/kg |
| Acute dermal in male rats LD50 | >2000 | mg/kg | >2000 | mg/kg | >2000 | mg/kg |
| Acute inhalation in female rats LD50 | >5000 | mg/m³ | >5000 | mg/m³ | >5000 | mg/m³ |
| Acute inhalation in male rats LD50 | >5000 | mg/m³ | >5000 | mg/m³ | >5000 | mg/m³ |

| | | | |
|---|---|---|---|
| Eye irritation in New | Recovered | Recovered | Recovered |
| Zealand White rabbits | within 30 h | within 34 h | within 36 h |
| Sensitization rate in | 0% | 0% | 0% |
| Hartley guinea pigs | | | |

As can be seen from the data in Table 8, the emulsifiable concentrate formulations of C. longa rhizome extract involved in the present application has high safety, slightly toxic, low irritation, and weak allergenicity.

### Test Example 9

The emulsifiable concentrate formulations of C. longa rhizome extract prepared by Application Examples 12-14 were subjected to environmental impact assessment.

All the environmental impact tests were conducted by Shenyang Research Institute of Chemical Industry with the following results:
(1) Acute oral toxicity in quails: according to the method referring to GB/T 31270.9-2014 Test guidelines on environmental safety assessment for chemical pesticides—Part 9 (female for 24 h/48 h/72 h/7 d);
(2) Acute oral toxicity in honeybees: according to the method referring to GB/T 31270.10-2014 Test guidelines on environmental safety assessment for chemical pesticides—Part 10 (female for 24 h/48 h);
(3) Acute contact toxicity in honeybees: according to the method referring to GB/T 31270.10-2014 Test guidelines on environmental safety assessment for chemical pesticides—Part 10 (male for 24 h/48 h); and
(4) Acute toxicity in silkworms: according to the method referring to GB/T 31270.11-2014 Test guidelines on environmental safety assessment for chemical pesticides—Part 11 (for 96 h).

The results are shown in Table 9.

TABLE 9

| | Application | Application | Application |
|---|---|---|---|
| Property | Example 12 | Example 13 | Example 14 |
| Acute oral toxicity in quails LD₅₀, (24 | >698 | >698 | >698 |
| h/48 h/72 h/7 d), mg a.i./kg weight | | | |
| Acute oral toxicity in honeybees LD₅₀, (24 | >99.3 | >99.3 | >99.3 |
| h/48 h), μg a.i./each honeybee | | | |
| Acute contact toxicity in honeybees LD₅₀, | >100 | >100 | >100 |
| (24 h/48 h), μg a.i./each honeybee | | | |
| Acute toxicity in silkworms LC₅₀, (24 h/48 | >500 | >500 | >500 |
| h/72 h/96 h), mg a.i./L | | | |

As can be seen from the data in Table 9, the emulsifiable concentrate formulations of C. longa rhizome extracts involved in the present application are environmentally friendly and have low toxicity to birds, honeybees, silkworms, and other terrestrial organisms in the environment.

### Test Example 10

The emulsifiable concentrate formulations of C. longa rhizome extract prepared by Application Examples 12-19 were subjected to tests for the prevention and control of pea powdery mildew.
(1) Cultivation of pea seedling: Pea seeds (variety: ‘Sweet Crisp’) were soaked in a Petri dish with water for 24 h at room temperature, then the water was drained, and moistened absorbent cotton was placed in the dish, and pea seeds were distributed evenly in the dish. The cotton was kept moist by daily watering. After approximately one week, when the pea seedlings reached a height of 2-3 cm, they were transplanted into small pots and watered every two days. Pea seedlings were selected for experiment when the first true leaf was fully expanded and the second true leaf had begun to unfold, ensuring they were healthy and of uniform size.
(2) Preparation of Erysiphe pisi DC. spore suspension: the spray method was used to inoculate the conidia suspension of the pathogen to pea seedlings, thereby it is necessary to prepare a spore suspension with an appropriate concentration, and the method is as follows:
(2.1) purified water was filled into a spray bottle, freshly developed powdery mildew spots on infected leaves were selected, and the spores were washed off into a clean beaker by gentle spraying; and
(2.2) the collected spore suspension was uniformly mixed, and one droplet was taken on a microscope slide and examined by a microscope to assess spore turgidity and morphology and observe the number of spores in the field of view at a magnification of 15*10× to check if it met the requirements. Requirements on the spore suspension: spores were plump in morphology to ensure the viability; 20-30 spores per field of view at the magnification of 15*10×, which was the optimal range; and the spore suspension needed to be used within 2 h from preparation to ensure the viability of spores.
(3) Inoculation of Erysiphe pisi DC.:
(3.1) the prepared spore suspension was uniformly sprayed onto pea leaves;
(3.2) the inoculated pea seedlings were transferred to a growth chamber, and the remaining spore suspension was sprayed inside the chamber to create a high humidity environment, then the chamber was covered and incubated at about 25° C. for 24 h; and
(3.3) after 24 h, the chamber was uncovered and the pea seedlings were taken out, and after the leaves were air-dried, the pea seedlings could be subjected to chemical treatment.
(4) Administration method:
(4.1) for each group, 0.1 mL emulsifiable concentrate formulation was diluted 200-fold with deionized water, filled into a spray bottle, and labeled for later use;
(4.2) preparation of agent for adjuvant-control group: according to the preparation formula, the content of the C. longa rhizome extract was replaced with water, and then an adjuvant solution was prepared with the same concentration of the adjuvant contained in the formulation; 0.1 mL the adjuvant solution was diluted 200-fold with water, filled into a spray bottle, and labeled for later use;
(4.3) preparation of agent for positive control group: fungicide tebuconazole suspension concentrate of 430 g/L was diluted 2000-fold with water, filled into a spray bottle, and labeled for later use;
(4.4) preparation of blank control group: deionized water was filled into a spray bottle, and labeled for later use;
(4.5) spraying: the inoculated pea seedlings were cultivated for 24 h, and treated with agents (4 replicates per treatment); leaves were sprayed with the corresponding agent evenly, and the standard was to cover the complete surface of the leaves;
(4.6) cultivation: the agent-treated pea seedlings were cultivated at about 25° C. and humidity around 70%, and watered every 2 days; and
(4.7) observation: the phytotoxicity symptom was observed 24 h and 5 days after the spraying, and agent causing severe phytotoxicity symptom was discarded according to the phytotoxicity symptom; the disease incidence of the remained agents was counted six days later to calculate the prevention and control effect, and the prevention and control changes were observed and recorded for several consecutive days.
(5) Efficacy evaluation:

10 plants were evaluated per group of samples, and all leaves were assessed per plant. The disease rating scale was as follows:
Grade 0: no lesions;
Grade 1: ≤5% leaf coverage with lesions;
Grade 3: 6-15% leaf coverage;
Grade 5: 16-25% leaf coverage;
Grade 7: 26-50% leaf coverage; and
Grade 9: ≥51% leaf coverage.

$$Disease index = [ \text{} \sum ( Number of diseased leaves at each grade \times Corresponding grade value ) ] \text{} / ( Total number of leaves assessed \times Highest disease index \times 9 ) \times 100$$

$$Control efficacy \% = ( disease index of control group after administraion - disease index of other group after administration ) / disease index of control group after administraion \times 100$$

The data of control efficacy is shown in Table 10.

TABLE 10

| | Control |
|---|---|
| Group | efficacy (%) |
| Application Example 12 | 85.71 |
| Application Example 13 | 82.38 |
| Application Example 14 | 83.26 |
| Application Example 15 | 74.82 |
| Application Example 16 | 72.25 |
| Application Example 17 | 80.96 |
| Application Example 18 | 78.22 |
| Application Example 19 | 75.43 |
| Adjuvant-control group | 0 |
| Positive control group | 85.47 |
| Blank control group | 0 |

As can be seen from the data in Table 10, the emulsifiable concentrate formulations of C. longa rhizome extract involved in the present application have excellent efficacy of pea powdery mildew prevention and control, wherein the preparation conditions of the C. longa rhizome extract and the formulation of the emulsifiable concentrate also affect this efficacy.

### Test Example 11

The emulsifiable concentrate formulations of C. longa rhizome extract prepared by Application Examples 12 and 15-17 were subjected to field efficacy trials against grape powdery mildew.
(1) Test target and crop variety

Grape variety: red globe; target pathogen: grape powdery mildew
(2) Test agents: the emulsifiable concentrate formulations from Application Examples 12 and 15-17diluted 500-fold with water for later use;
agent for positive control: 325 g/L azoxystrobin SC from Zhejiang Tianfeng Bioscience Co., Ltd. with a registration No.: PD20172823 and a batch No.: 20210318, diluted 1000 times for later use; simultaneously, a water-only control group was set.
(3) Trial location: Zengjiaying Village, Binchuan County, Dali, Yunnan, China
block arrangement: the experiment set up 6 processes, each treatment had 4 block repeats, and each block repeated an area of 15 m².
(4) Administration method: a 20-type knapsack electric sprayer from Zhengzhou Xinxiu Agricultural Machinery Co., Ltd. was used for application, and formulations were prepared according to the experimental design and sprayed uniformly onto plants across all treatments until runoff;

Application were conducted during the initial disease onset stage (when sporadic lesions appeared on lower leaves) twice at 8-day intervals, and the application dates were recorded.
(5) Assessment method

5 points were assessed per treatment group, 2 plants were included in each point, and all leaves were assessed per plant.

The disease rating scale was as follows:
Grade 0: no lesions;
Grade 1: ≤5% leaf coverage with lesions;
Grade 3: 6-10% leaf coverage;
Grade 5: 11-20% leaf coverage;
Grade 7: 21-40% leaf coverage; and
Grade 9: >40% leaf coverage.
(6) Calculation method for efficacy

$$Disease index = [ \text{} \sum ( Number of diseased leaves at each grade \times Corresponding grade value ) ] \text{} / ( Total number of leaves assessed \times 9 ) \times 100$$

$$Control efficacy \% = [ 1 - disease index of treament block / disease index of control group ) ] \times 100$$

The results were shown in Table 11.

TABLE 11

| | | Positive | | | | |
|---|---|---|---|---|---|---|
| | Control | control | Application | Application | Application | Application |
| Assessment date | group | group | Example 12 | Example 15 | Example 16 | Example 17 |
| Efficacy after 8 | / | 60.85% | 73.42% | 64.77% | 62.86% | 70.95% |
| days of the first | | | | | | |
| administration | | | | | | |
| Efficacy after 8 | / | 64.47% | 81.62% | 71.69% | 72.34% | 77.38% |
| days of the second | | | | | | |
| administration | | | | | | |

As can be seen from the data in Table 11, the emulsifiable concentrate formulations of C. longa rhizome extract involved in the present application have excellent efficacy of grape powdery mildew prevention and control, wherein the preparation conditions of the C. longa rhizome extract and the formulation of the emulsifiable concentrate also affect this efficacy.

### Test Example 12

The emulsifiable concentrate formulations of C. longa rhizome extract prepared by Application Examples 12 and 15-17 were subjected to field efficacy trials against rose powdery mildew.
(1) Test target and crop variety

Rose variety: awakening; target pathogen: rose powdery mildew
(2) Test agents: the emulsifiable concentrate formulations from Application Examples 12 and 15-17 diluted 500-fold with water for later use;
agent for positive control: 25% bupirimate ME from Xi'an MTI Co., Ltd. with a registration No.: PD20190149 and a batch No.: 20201023018, diluted 1000 times for later use; simultaneously, a water-only control group was set.
(3) Trial location: Goujie Town, Yiliang County, Kunming, Yunnan, China
block arrangement: the experiment set up 6 processes, each treatment had 4 block repeats, and each block repeated an area of 15 m2.
(4) Administration method: a 20-type knapsack electric sprayer from Zhengzhou Xinxiu Agricultural Machinery Co., Ltd. was used for application the formulations prepared according to the experimental design and sprayed uniformly onto plants across all treatments until runoff.
Application were conducted during the initial disease onset stage (i.e., when sporadic lesions appeared on lower leaves) once, and the application dates were recorded.
(5) Assessment method
5 points were assessed per treatment group, 2 plants were included in each point, and all leaves were assessed per plant.

The disease rating scale was as follows:
Grade 0: no lesions;
Grade 1: ≤5% leaf coverage with lesions;
Grade 3: 6-10% leaf coverage;
Grade 5: 11-20% leaf coverage;
Grade 7: 21-40% leaf coverage; and
Grade 9: ≥40% leaf coverage.
(6) Calculation method for efficacy

$$Disease index = [ \text{} \sum ( Number of diseased leaves at each grade \times Corresponding grade value ) ] \text{} / ( Total number of leaves assessed \times 9 ) \times 100$$

$$Control efficacy \% = [ 1 - disease index of treament block / disease index of control group ) ] \times 100$$

The results were shown in Table 12.

TABLE 12

| | Control efficacy after 7 days |
|---|---|
| Group | of the once application |
| Control group | / |
| Positive control group | 65.53% |
| Application Example 12 | 75.46% |
| Application Example 15 | 61.25% |
| Application Example 16 | 60.88% |
| Application Example 17 | 72.21% |

As can be seen from the data in Table 12, the emulsifiable concentrate formulations of C. longa rhizome extract involved in the present application have excellent efficacy of rose powdery mildew prevention and control, wherein the preparation conditions of the C. longa rhizome extract and the formulation of the emulsifiable concentrate formulation also affect this efficacy.

The applicant declares that the present application illustrates the detailed technical solutions of the present application by the above examples, but the present application is not limited to the above examples, that is, the present application does not necessarily rely on the above examples to be implemented. Those skilled in the art should understand that any improvements of the present application, the equivalent substitution of each raw material, the addition of auxiliary ingredients, and the selection of specific methods shall fall within the protection scope and disclosure scope of the present application.

The above describes in detail the preferred embodiments of the present application. However, the present application is not limited to the specific details in the above embodiments, and various simple variations of the technical solutions of the present application can be made within the scope of the technical conception of the present application, all of these simple variations shall fall within the protection scope of the present application.

It is also to be noted that the various specific technical features described in the above specific embodiments may be combined in any suitable manners without contradiction, and in order to avoid unnecessary repetition, the various possible combinations are not described separately in the present application.

What is claimed is:

1. A method for preparing a Curcuma longa rhizome extract, comprising:
(1) drying and crushing a raw material of Curcuma longa rhizome, and performing extraction with an aqueous ethanol solution to obtain an extract solution;
(2) concentrating the extract solution, and then performing extraction with an organic solvent to obtain an aqueous-phase product and an oil-phase product; and
(3) subjecting the oil-phase product to molecular distillation to remove turmeric oleoresin to obtain the Curcuma longa rhizome extract.

2. The method for preparing a Curcuma longa rhizome extract according to claim 1, wherein a concentration of the aqueous ethanol solution is 55-95%, and preferably 65-85%;
preferably, a solid-to-liquid ratio of the raw material of Curcuma longa rhizome to the aqueous ethanol solution is (20-150) g/L, and preferably (30-70) g/L.

3. The method for preparing a Curcuma longa rhizome extract according to claim 1, wherein the extraction is performed at a temperature of 10-60° C., and preferably 15-30° C.;
preferably, the extraction is performed for a period of 24-96 h, and preferably 30-50 h.

4. The method for preparing a Curcuma longa rhizome extract according to claim 1, wherein the organic solvent comprises any one or a combination of at least two of n-hexane, petroleum ether, cyclohexane, isooctane, trifluoroacetic acid, trimethylpentane, cyclopentane, heptane, butyryl chloride, trichloroethylene, carbon tetrachloride, propyl ether, or toluene.

5. The method for preparing a Curcuma longa rhizome extract according to claim 1, wherein the molecular distillation is performed under a pressure condition of 0.1-10 Pa, and preferably 0.1-5 Pa;
preferably, the molecular distillation is performed at a temperature of 100-150° C., and preferably 110-130° C.

6. An emulsifiable concentrate formulation of Curcuma longa rhizome extract, comprising the following components by mass percentage: 30-70% of the Curcuma longa rhizome extract prepared by the preparation method according to claim 1, 10-35% of an emulsifier, and 15-50% of a solvent.

7. The emulsifiable concentrate formulation of Curcuma longa rhizome extract according to claim 6, wherein the emulsifiable concentrate formulation of Curcuma longa rhizome extract comprises the following components by mass percentage: 40-60% of the Curcuma longa rhizome extract prepared by the preparation method, 20-30% of the emulsifier, and 15-35% of the solvent.

8. The emulsifiable concentrate formulation of Curcuma longa rhizome extract according to claim 6, wherein the solvent comprises any one or a combination of at least two of methyl oleate, soybean oil, corn oil, rapeseed oil, or pine-based oil.

9. The emulsifiable concentrate formulation of Curcuma longa rhizome extract according to claim 6, wherein the emulsifier comprises a non-ionic emulsifier and an anionic emulsifier;
preferably, the non-ionic emulsifier comprises any one or a combination of at least two of polyoxyethylene tristyrylphenol ether, polyoxyethylene sorbitan trioleate, tristyrylphenol ethoxylate-propoxylate, or castor oil polyglycol ether ester;
preferably, the anionic emulsifier is selected from any one or a combination of at least two of a diphenyl sulfonate, an α-olefin sulfonate, a lignosulfonate, a sulfonate of ethoxylated alkylphenol, a sulfonate of alkoxylated arylphenol, a sulfonate of condensed naphthalene, a sulfonate of dodecylbenzene or tridecylbenzene, a sulfonate or a sulfosuccinate of naphthalene or alkylnaphthalene;
preferably, the emulsifier comprises the following components by mass percentage: 30-40% of polyoxyethylene tristyrylphenol ether, 30-40% of polyoxyethylene sorbitan trioleate, and 25-35% of calcium dodecylbenzene sulfonate.

10. The emulsifiable concentrate formulation of Curcuma longa rhizome extract according to claim 6, wherein a component of the emulsifiable concentrate formulation of Curcuma longa rhizome extract further comprises any one or a combination of at least two of a synergist, a defoamer, or an adhesive.

11. The emulsifiable concentrate formulation of Curcuma longa rhizome extract according to claim 6, wherein a method for preparing the emulsifiable concentrate formulation of Curcuma longa rhizome extract comprises: mixing a formulated amount of the emulsifier and the solvent, and performing a primary emulsification, then mixing with the Curcuma longa rhizome extract, and performing a secondary emulsification, to obtain the product;
preferably, the emulsification is performed under stirring, and a rotational speed of the stirring is 3000-8000 rpm;
preferably, the primary emulsification and the secondary emulsification are independently performed for a period of 3-10 min.

12. A method of preventing and controlling plant powdery mildew, comprising applicating an effective amount of the Curcuma longa rhizome extract prepared by the preparation method according to claim 1 to a plant in need thereof;
wherein the plant comprises Leguminosas, Rosaceae, and Vitaceae plants.
